(19) United States
(12) Patent Application Publication
(10) Pub. No.: US 2013/0238583 A1
(43) Pub. Date: Sep. 12, 2013

(54) ENTERPRISE PORTAL CONTEXTUAL SEARCH

(71) Applicants: Doron LEHMANN, Kfar Vradim (IL); Nimrod BARAK, Tel Aviv (IL)

(72) Inventors: Doron LEHMANN, Kfar Vradim (IL); Nimrod BARAK, Tel Aviv (IL)

(73) Assignee: SAP Portals Israel Ltd., Raanana (IL)

(21) Appl. No.: 13/415,177

(22) Filed: Mar. 8, 2012

(51) Int. Cl. G06F 17/30

(52) U.S. Cl. 707/706; 707/E17.108

(57) ABSTRACT

The disclosure generally describes computer-implemented methods, software, and systems for optimizing enterprise portal searching. A computer-implemented method includes receiving, using at least one computer, a search request associated with a navigation node, ranking available search engines, receiving a selection of a search engine of the ranked available search engines and at least one search term, recording context data associated with the received search engine selection and the at least one search term, performing a search using the selected search engine and the at least one search term, receiving search results, and determining relevance of the returned search results.

### TECHNICAL FIELD

The present disclosure relates to computer-implemented methods, software, and systems for optimizing enterprise portal searching.

### BACKGROUND

In an enterprise portal, a user can search using either an internally implemented search engine or external search engines providing access to a variety of third-party search providers. It is difficult for the user to know which search engine and/or search provider is most suitable for the user's needs and which returned search results optimally respond to the user's search request.

### SUMMARY

The present disclosure relates to computer-implemented methods, software, and systems for optimizing enterprise portal searching. One computer-implemented method includes: receiving, using at least one computer, a search request associated with a navigation node, ranking available search engines, receiving a selection of a search engine of the ranked available search engines and at least one search term, recording context data associated with the received search engine selection and the at least one search term, performing a search using the selected search engine and the at least one search term, receiving search results, and determining relevance of the returned search results.

Other implementations of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination. In particular, one implementation can include all the following features:

In a first aspect, combinable with the general implementation, the ranking of the available search engines includes: receiving context data associated with at least the navigation node, receiving metadata from the navigation node, receiving metadata from the available search engines, analyzing the received context data, comparing the metadata received from the navigation node and the available search engines, and based upon the comparison, determining a ranking of the available search engines.

In a second aspect, combinable with any of the previous aspects, the metadata comparison is at least one of a direct, statistical, Boolean, or logical.

In a third aspect, combinable with any of the previous aspects, the recorded context data includes at least one of a navigation node view, the selected search engine of the ranked available search engines, the at least one search term, or a role.

A fourth aspect, combinable with any of the previous aspects, includes determining whether a search result of the returned search results was selected.

A fifth aspect, combinable with any of the previous aspects, includes determining whether at least one other enterprise portal user selected the same received search result from the same search engine.

A sixth aspect, combinable with any of the previous aspects, includes determining whether an additional search was performed with the same search terms and a different search engine.

The subject matter described in this specification can be implemented in particular implementations so as to realize one or more of the following advantages. First, a search provider is selected by default and recommended to a user depending upon the context of the displayed enterprise portal page. Second, a search provider may be selected for the user based upon another user's selection on that search provider. Third, a search provider may be ranked against other search providers by determining if results returned by the search provider provided relevant results. Fourth, search results may be prioritized by analyzing the use of the search results by other users. Fifth, search results for different computing platforms may be optimized. Other advantages will be apparent to those skilled in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example system for optimizing enterprise portal searching.

FIG. 2 is a flowchart of an example method for optimizing enterprise portal searching.

FIG. 3 is a flowchart of an example method for ranking search engines.

FIG. 4 is a flowchart of an example method for determining the relevance of returned search results.

Like reference numbers and designations in the various drawings indicate like elements.

### DETAILED DESCRIPTION

The disclosure generally describes computer-implemented methods, software, and systems for optimizing enterprise portal searching. An enterprise portal, also known as an enterprise information portal (EIP) or a corporate portal, is a framework for integrating information, people and processes across organizational boundaries. The enterprise portal provides a secure unified access point, often in the form of a Web-based user interface, and is designed to aggregate and personalize information through application-specific portals. The enterprise portal is the de-centralized content contribution and content management system, which keeps the information always updated. With only a Web browser, users can begin work once they have been authenticated in the portal which offers a single point of access to information, enterprise applications, and services both inside and outside an organization. Portals may present information from diverse sources in a unified way, and provide additional services, such as dashboards, an internal search engine, e-mail, news, and various other features. Portals are often used by enterprises for providing their employees, customers, and possibly additional users with a consistent look and feel, and access control and procedures for multiple applications, which otherwise would have been separate entities altogether.

A business object can be considered a representation of a business entity, such as an employee, a sales order, an invoice, a financial report, etc. The business object may encompass both functions, for example in the form of methods, and data, such as one or more properties. For example, business objects may reduce system complexity by reducing a system into smaller units. The implementation details of business objects are typically hidden from a non-development user and may be accessed through the defined functions and encapsulated data. Business objects also form a point of entry of the functions and data of a system and enable the system to easily share, communicate, display, or otherwise operate with other systems.

Generally, through a graphical user interface (GUI), an enterprise portal user is provided with an efficient and user-friendly presentation of data provided by or communicated within the system. The term “graphical user interface,” or GUI, may be used in the singular or the plural to describe one or more graphical user interfaces and each of the displays of a particular graphical user interface. Therefore, a GUI may represent any graphical user interface, including but not limited to, a Web browser, a touch screen, or a command line interface (CLI) that processes information and efficiently presents the information results to the user. In general, a GUI may include a plurality of user interface (UI) elements, some or all associated with a Web browser, such as interactive fields, pull-down lists, and buttons operable by the enterprise portal user. These and other UI elements may be related to or represent the functions of the Web browser.

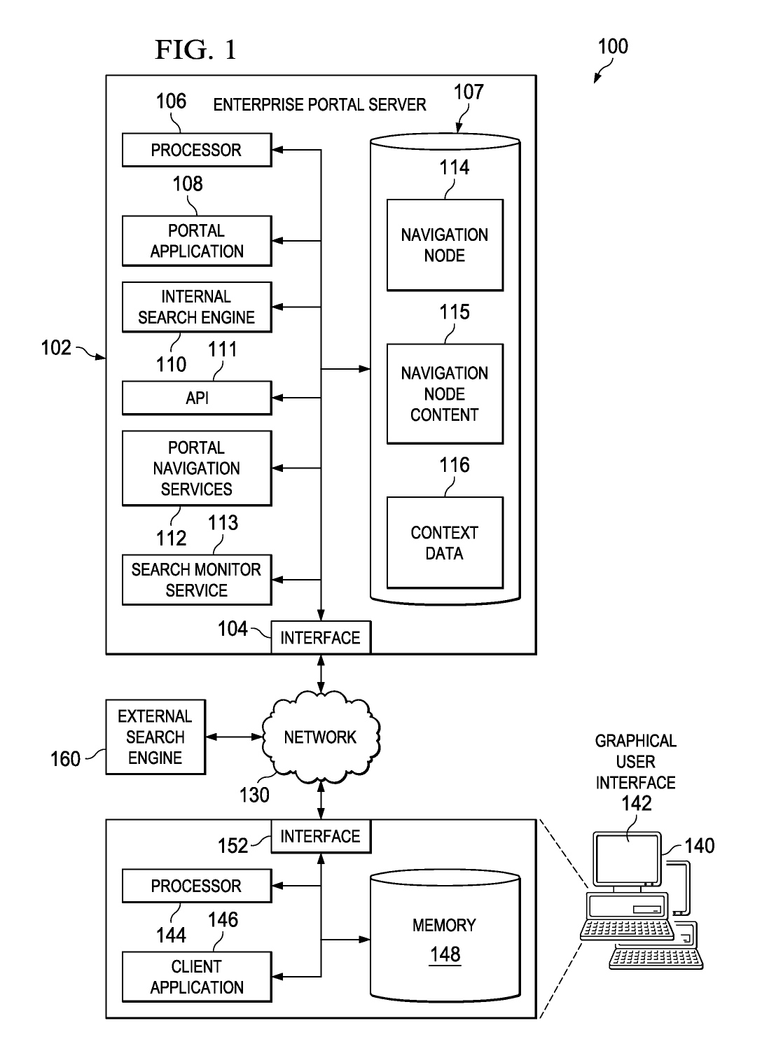

FIG. 1 illustrates an example distributed computing system 100 operable to optimize enterprise portal searching. Specifically, the illustrated environment 100 includes or is communicably coupled with an enterprise portal server 102, a client 140, and an external search engine that communicate across a network 130.

In general, the enterprise portal server 102 is a server that stores one or more portal applications 108, where at least a portion of the portal applications 108 are executed via requests and responses sent to users or clients within and communicably coupled to the illustrated environment 100 of FIG. 1. In some implementations, the enterprise portal server 102 may store a plurality of various portal applications 108, while in other implementations, the enterprise portal server 102 may be a dedicated server meant to store and execute only a single portal application 108. In some implementations, the enterprise portal server 102 may comprise a Web server, where the portal applications 108 represent one or more Web-based applications accessed and executed by the client 140 via the network 130 or directly at the enterprise portal server 102 to perform the programmed tasks or operations of the portal application 108.

At a high level, the enterprise portal server 102 comprises an electronic computing device operable to receive, transmit, process, store, or manage data and information associated with the environment 100. Specifically, the enterprise portal server 102 illustrated in FIG. 1 is responsible for receiving application requests from one or more client applications associated with the client 140 of the environment 100 and responding to the received requests by processing said requests in the associated portal application 108, and sending the appropriate response from the portal application 108 back to the requesting client application 146. In addition to requests from the client 140, requests associated with the portal applications may also be sent from internal users, external or third-party customers, other automated applications, as well as any other appropriate entities, individuals, systems, or computers.

As used in the present disclosure, the term “computer” is intended to encompass any suitable processing device. For example, although FIG. 1 illustrates a single enterprise portal server 102, environment 100 can be implemented using two or more servers 102, as well as computers other than servers, including a server pool. Indeed, enterprise portal server 102 may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, illustrated enterprise portal server 102 may be adapted to execute any operating system, including Linux, UNIX, Windows, Mac OS, Java, Android, iOS or any other suitable operating system. According to one implementation, enterprise portal server 102 may also include or be communicably coupled with an e-mail server, a Web server, a caching server, a streaming data server, and/or other suitable server.

The enterprise portal server 102 also includes an interface 104, a processor 106, and a memory 107. The interface 104 is used by the enterprise portal server 102 for communicating with other systems in a distributed environment—including within the environment 100—connected to the network 130; for example, the client 140, as well as other systems communicably coupled to the network 130 (not illustrated). Generally, the interface 104 comprises logic encoded in software and/or hardware in a suitable combination and operable to communicate with the network 130. More specifically, the interface 104 may comprise software supporting one or more communication protocols associated with communications such that the network 130 or interface's hardware is operable to communicate physical signals within and outside of the illustrated environment 100.

As illustrated in FIG. 1, the enterprise portal server 102 includes a processor 106. Although illustrated as a single processor 106 in FIG. 1, two or more processors may be used according to particular needs, desires, or particular implementations of the environment 100. Each processor 106 may be a central processing unit (CPU), a blade, an application specific integrated circuit (ASIC), a field-programmable gate array (FPGA), or another suitable component. Generally, the processor 106 executes instructions and manipulates data to perform the operations of the enterprise portal server 102. Specifically, the processor 106 executes the functionality required to receive and respond to requests from the client 140 and/or searching functionality.

Regardless of the particular implementation, “software” may include computer-readable instructions, firmware, wired and/or programmed hardware, or any combination thereof on a tangible medium (transitory or non-transitory, as appropriate) operable when executed to perform at least the processes and operations described herein. Indeed, each software component may be fully or partially written or described in any appropriate computer language including C, C++, Java, Visual Basic, assembler, Perl, any suitable version of 4GL, as well as others. While portions of the software illustrated in FIG. 1 are shown as individual modules that implement the various features and functionality through various objects, methods, or other processes, the software may instead include a number of sub-modules, third party services, components, libraries, and such, as appropriate. Conversely, the features and functionality of various components can be combined into single components as appropriate.

The enterprise portal server 102 also includes a memory 107, or multiple memories 107. The memory 107 may include any memory or database module and may take the form of volatile and/or non-volatile memory including, without limitation, magnetic media, optical media, random access memory (RAM), read-only memory (ROM), removable media, or any other suitable local or remote memory component. The memory 107 may store various objects or data, including caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the enterprise portal server 102. Additionally, the memory 107 may include any other appropriate data, such as VPN applications, firmware logs and policies, firewall policies, a security or access log, print or other reporting files, as well as others.

The enterprise portal server 102 further includes an application programming interface (API) 111. The API 111 may be used to interface between the portal application 108, internal search engine 110, portal navigation services, and/or search engine monitor service 113. For example, in some implementations, the portal application 108 can utilize API 111 to communicate with the internal search engine 110 and/or the external search engine 160 when requesting a search or receiving search results.

The memory 107 includes a navigation node 114, navigation node content 115, and context data 116. Although illustrated as single components, there may be more than one navigation node 114, navigation node content 115, and context data 116.

The navigation node 114 can be considered the target of a request for data in an enterprise portal, for example a Web page or the final destination of a navigation action, etc. A navigation node 114 contains the view to be displayed when the navigation node is accessed. In some implementations, the navigation node 114 can control the location of a selected view, personalized views, and dynamic views. In some implementations, a navigation node 114 may be considered a business object. Each navigation node 114 in the enterprise portal also contains metadata regarding the displayed data, for example sales, revenue, salary, reporting, customers, etc. This metadata may be used to determine the context of a particular displayed view.

The navigation node content 115 is the textual, visual or aural content that is encountered as part of the user experience when accessing a navigation node 114 within an enterprise portal. The navigation node content 115 may include, among other things: text, images, sounds, videos and animations. While illustrated as integrated with memory 107 of the enterprise portal server in the example environment 100 of FIG. 1, in alternative implementations the navigation node content 115 can be external to the enterprise portal server 102 and/or from the example environment 100 or internal to the navigation node 114.

The enterprise portal server 102 further includes portal navigation services 112. Generally, the portal navigation services 112 are responsible for the creation of the content hierarchy in the portal, and to provide access to all of the additional services provided in the “shell” of the portal (e.g., searching capabilities, personalization, modification, deletion, etc.). For example, the navigation services 112 may create a tree of navigation nodes for each user who enters the portal. As discussed above, each navigation node 114 represents specific content, or a collection of content, that can be viewed by the user. For each user, the portal navigation services 112 are responsible for generating a navigation tree of links to the portal content assigned to the user. An application—for example, a client running on a user's machine or an application running in the enterprise portal—can query the navigation services 112 for the current user's navigation hierarchy or tree, and then display this tree to the user. In some implementations, portal applications 108 can communicate with the navigation services 112 directly and/or via API 111. In some implementations, internal/external services, software, and/or other components, including those not illustrated, can communication with the navigation services 112 directly and/or via the API 111.

The illustrated enterprise portal server 102 further includes an internal search engine 110 or multiple internal search engines 110. The internal search engine 110 may be any computing device operable connect to or communicate with at least the enterprise portal server 102, the client 140, and/or the external search engine 160 via the network 130 using a wireline or wireless connection. In general, the internal search engine 110 comprises an electronic computer device operable to receive, transmit, process, and store any appropriate data associated with the environment 100 of FIG. 1 and to perform searching for data related to a search request received from either the enterprise portal server 102, the client 140, and/or the external search engine 160. The internal search engine 110 may search data on the enterprise portal server 102, client 140, and/or other data external to environment 100 (not illustrated). In some implementations, the internal search engine 110 may communicate with other enterprise portal server 102 and/or client 140 components using API 111, the portal navigation services 112, and/or the search monitor service 113.

The illustrated enterprise portal server 102 further includes a search monitor service 113. In some implementations, the search monitor service 113 operates in real-time. In other implementations, the search monitor service 113 is triggered by the action(s) of some other software or hardware component(s), for example an enterprise portal user's request on a GUI to perform a search. In other implementations, the search monitor service may automatically disable itself due to some determined criteria, such as a timeout, a specific user action, etc. The search monitor service 113 may perform various functions in order to optimize enterprise portal searching by using contextual binding between an enterprise portal user's navigation node 114 view and a requested search with a search engine(s).

First, the search monitor service 113 may rank and select a most suitable search engine. Search engines maintain metadata indicating which searches they may perform. This search engine metadata allows an application to decide whether a search engine is appropriate to make a search request of and the scope of possible search results that may be received. For example, if a first search engine reflects metadata that a search for “German Walldorf Breweries” is supported and a second search engine reflects metadata that a search for “European breweries” is supported, one determination that can be made is that the first search engine may return more focused and/or relevant results. By calculating which search engine's metadata correlates most closely to the metadata (i.e., context) of a specific navigation node 114 view, the application can select the most suitable search engine for a given search given the context of the navigation node 114 view. In some implementations, the closest correlation determination between metadata can be performed by a direct, statistical, Boolean, logical, or other suitable comparison of metadata. The search monitor service 113 may then rank and present search engine(s) in some determined order to the enterprise portal user based upon context data 116 (discussed below) and the compared metadata. In some implementations, additional ranking processing can be performed.

Second, during searches performed by enterprise portal users, the search monitor service 113 may record context data 116 identifying search engine(s) selected by the enterprise portal users and the associated enterprise portal user's navigation node 114 view(s). Following the selection of the search engine(s) by the enterprise portal users, the strength of a correlation between metadata of the search engines(s) and the navigation node 114 view(s) may be recorded as well as whether the enterprise portal user ran additional searches on the same navigation node 114 view and whether additional searches were associated with prior searches (i.e. narrowed and/or broadened the prior searches, etc.). By analyzing the context data 116, a correlation may be made that certain search providers return relevant content for specific navigation node 114 views that may be considered as a factor in a determination as to which search engine is most relevant for a specific navigation node 114 view. In some implementations, context data 116 may be recorded as text, binary, or in another suitable method. While illustrated as internal to memory 107 of enterprise portal server 102, the context data 116 can be stored external to enterprise portal server 102.

Third, the search monitor service 113 may determine if retrieved search results from a first search engine were relevant for a specific search term(s) entered by an enterprise portal user. In some implementations, this determination can be made by analyzing whether the enterprise portal user selected one of the returned search results and whether the user subsequently searched again for the specific search term(s) with a second search engine. For example, performing another search for the same specific search term(s) with a second search engine is evidence that the retrieved search results from the first search engine were not relevant or at least less relevant than the enterprise portal user desired. In addition, performing an additional search following one or more selections of the originally returned search results may provide additional evidence of increased non-relevance as the enterprise portal user has presumptively investigated the returned search results in greater detail and decided to perform another search as the results were not enough to satisfy the enterprise portal user. In some implementations, data reflecting this determination can be recorded to the context data 116.

Fourth, selected retrieved search results may be associated by the search monitor service 113 with the specific navigation node 114 view (i.e., context) and this data recorded in the context data 116. In some implementations, this data can be analyzed in light of multiple enterprise portal users and the analysis results used to prioritize search results for a specific enterprise portal user based upon available search engines and the enterprise portal user's navigation node 114 view. For example, if according to data in context data 116, existing enterprise portal user contexts of “AA,” “BB,” and “CC” have consistently selected the third search result “SearchResult3” from the “DataSearcher” search engine for the search term “MySearchTerm,” the search monitor service 113 may determine in the next search for “MySearchTerm” by an enterprise portal user with a context of “AA”, “BB,” or “CC,” that the “SearchResult3” search term will be listed first in the search results. In some implementations, this determination may be made by the number or prior searches, the role of the enterprise portal user (e.g., a general user, an administrator, executive, etc.), or other suitable criteria.

Additionally, in some implementations, the search monitor service 113 can associate a contextual binding between an enterprise portal user's navigation node 114 view and a requested search to a specific platform accessing the enterprise portal. For example, there may be a first context data 116 associated with on-premise computers, a second context data 116 associated with mobile devices, a third context data 116 associated with cloud-based platform computers, etc. In these implementations, each of these separate property context data 116 can be independently managed by the search monitor service 113. In other implementations, context data 116 may be further personalized by individual user, user role, geographic location, or other suitable criteria.

The illustrated environment of FIG. 1 also includes the client 140, or multiple clients 140. The client 140 may be any computing device operable to connect to or communicate with at least the enterprise portal server 102 via the network 130 using a wireline or wireless connection. In general, the client 140 comprises an electronic computer device operable to receive, transmit, process, and store any appropriate data associated with the environment 100 of FIG. 1.

The illustrated client 140 further includes a client application 146. The client application 146 is any type of application that allows the client 140 to request and view content on the client 140. In some implementations, the client application 146 can be and/or include a Web browser. In some implementations, the client-application 146 can use parameters, metadata, and other information received at launch to access a particular set of data from the server 102. Once a particular client application 146 is launched, a user may interactively process a task, event, or other information associated with the server 102. Further, although illustrated as a single client application 146, the client application 146 may be implemented as multiple client applications in the client 140.

The illustrated client 140 further includes an interface 152, a processor 144, and a memory 148. The interface 152 is used by the client 140 for communicating with other systems in a distributed environment—including within the environment 100—connected to the network 130; for example, the enterprise portal server 102, as well as other systems communicably coupled to the network 130 (not illustrated). Generally, the interface 152 comprises logic encoded in software and/or hardware in a suitable combination and operable to communicate with the network 130. More specifically, the interface 152 may comprise software supporting one or more communication protocols associated with communications such that the network 130 or interface's hardware is operable to communicate physical signals within and outside of the illustrated environment 100.

As illustrated in FIG. 1, the client 140 includes a processor 144. Although illustrated as a single processor 144 in FIG. 1, two or more processors may be used according to particular needs, desires, or particular implementations of the environment 100. Each processor 144 may be a central processing unit (CPU), an application specific integrated circuit (ASIC), a field-programmable gate array (FPGA), or another suitable component. Generally, the processor 144 executes instructions and manipulates data to perform the operations of the client 140. Specifically, the processor 144 executes the functionality required to send requests to the enterprise portal server 102 and to receive and process responses from the enterprise portal server 102.

The illustrated client 140 also includes a memory 148, or multiple memories 148. The memory 148 may include any memory or database module and may take the form of volatile or non-volatile memory including, without limitation, magnetic media, optical media, random access memory (RAM), read-only memory (ROM), removable media, or any other suitable local or remote memory component. The memory 148 may store various objects or data, including caches, classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the client 140. Additionally, the memory 148 may include any other appropriate data, such as VPN applications, firmware logs and policies, firewall policies, a security or access log, print or other reporting files, as well as others.

There may be any number of clients 140 associated with, or external to, the environment 100. For example, while the illustrated environment 100 includes one client 140, alternative implementations of the environment 100 may include multiple clients 140 communicably coupled to the enterprise portal server 102 and/or the network 130, or any other number suitable to the purposes of the environment 100. Additionally, there may also be one or more additional clients 140 external to the illustrated portion of environment 100 that are capable of interacting with the environment 100 via the network 130. Further, the term “client” and “user” may be used interchangeably as appropriate without departing from the scope of this disclosure. Moreover, while the client 140 is described in terms of being used by a single user, this disclosure contemplates that many users may use one computer, or that one user may use multiple computers.

The illustrated client 140 is intended to encompass any computing device such as a desktop computer, laptop/notebook computer, wireless data port, smart phone, personal data assistant (PDA), tablet computing device, one or more processors within these devices, or any other suitable processing device. For example, the client 140 may comprise a computer that includes an input device, such as a keypad, touch screen, or other device that can accept user information, and an output device that conveys information associated with the operation of the enterprise portal server 102 or the client 140 itself, including digital data, visual information, or a graphic user interface (GUI) 142, as shown with respect to the client 140.

Further, the illustrated client 140 includes the GUI 142. The GUI 142 interfaces with at least a portion of the environment 100 for any suitable purpose, including generating a visual representation of a Web browser. In particular, the GUI 142 may be used to view and navigate various Web pages located both internally and externally to the enterprise portal server 102.

The illustrated environment of FIG. 1 also includes an external search engine 160, or multiple external search engines 160 provided by one or more search providers. The search engine 160 may be any computing device operable connect to or communicate with at least the enterprise portal server 102 and/or client 140 via the network 130 using a wireline or wireless connection. In general, the search engine 160 comprises an electronic computer device operable to receive, transmit, process, and store any appropriate data associated with the environment 100 of FIG. 1 and to perform searching for data related to a search request received from either the enterprise portal server 102 and/or the client 140. The search engine 160 may search data on the enterprise portal server 102, client 140, and/or other data external to environment 100 (not illustrated).

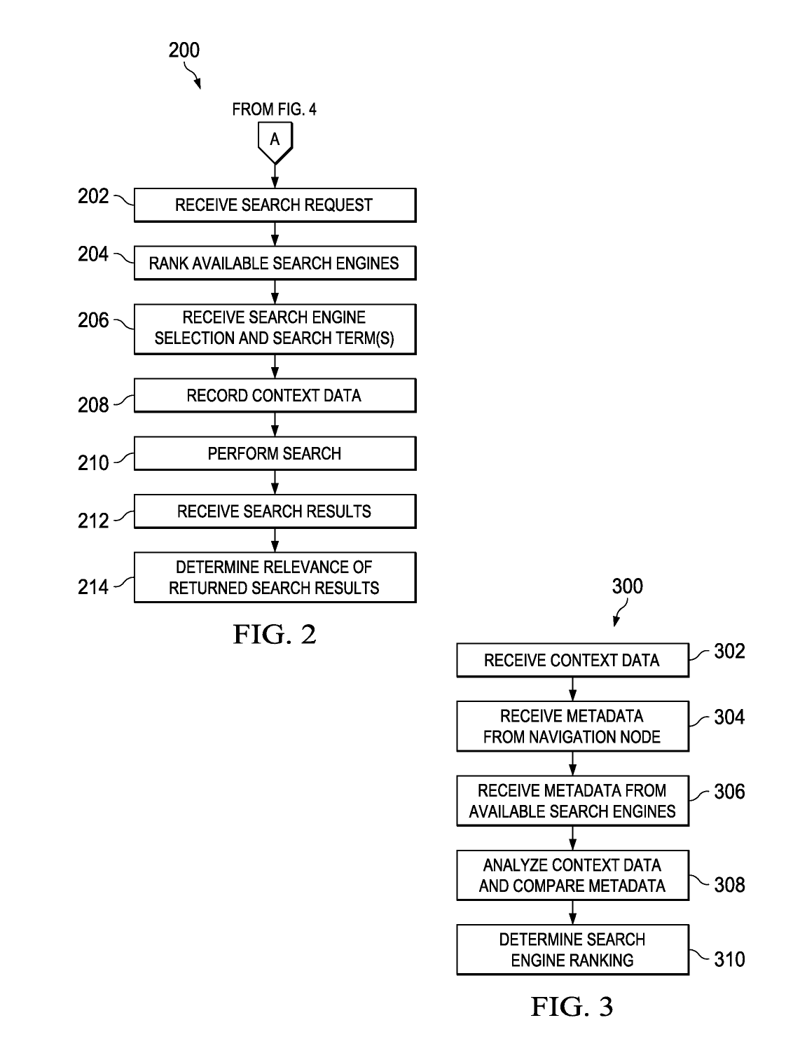

Turning now to FIG. 2, FIG. 2 is a flowchart illustrating an example method 200 for optimizing enterprise portal searching. For clarity of presentation, the description that follows generally describes method 200 in the context of FIG. 1. However, it will be understood that method 200 may be performed, for example, by any other suitable system, environment, software, and hardware, or a combination of systems, environments, software, and hardware as appropriate. For example, one or more of the enterprise portal server, the client, or other computing device (not illustrated) can be used to execute method 200 and obtain any data from the memory of the client, the enterprise portal server, or the other computing device (not illustrated).

At 202, a search request is received. In some implementations, an enterprise portal user can make the search request using a GUI as described above or other suitable interface, for example voice recognition or an optical scanner. From 202, method 200 proceeds to 204.

At 204, available search engines are ranked prior to presentation to an enterprise portal user. For additional detail as to ranking, see FIG. 3 and its associated description. From 204, method 200 proceeds to 206.

At 206, a search engine selection and a search term(s) is received. In some implementations, an enterprise portal user can select the search engine and enter a search term(s) using a GUI as described above or other suitable interface. In some implementations, the search engine selection and the search term(s) are received by the search monitor service. From 206, method 200 proceeds to 208.

At 208, context data is recorded. In some implementations, the recorded context data can reflect the enterprise portal user's navigation node view, the selected search engine, and/or the entered search term(s). In other implementations, additional data such as the enterprise portal user's role or other suitable data can be recorded to the context data. From 208, method 200 proceeds to 210.

At 210, a search is performed at the selected search engine using the entered search term(s). From 210, method 200 proceeds to 212.

At 212, search results are received from the search engine. From 212, method 200 proceeds to 214.

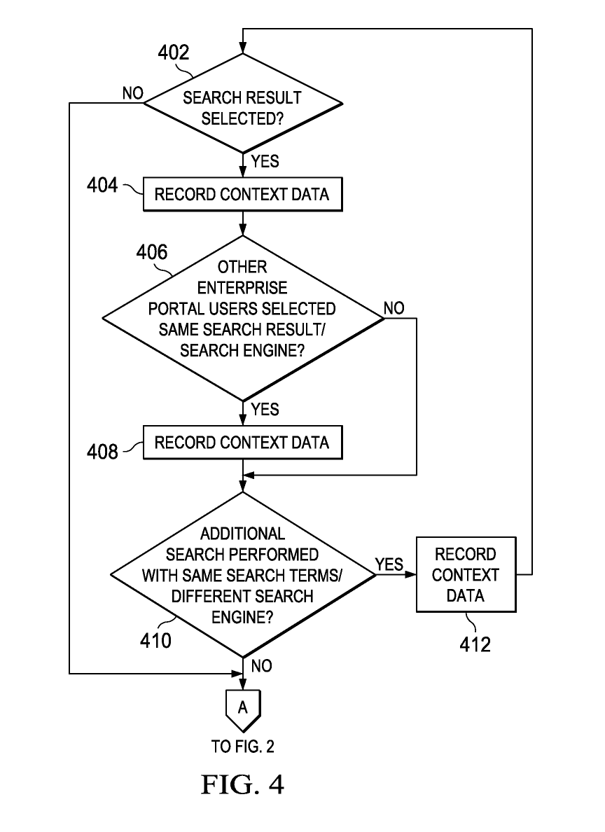

At 214, relevance of the returned search results is determined. For additional detail as to the determination, see FIG. 4 and its associated description. From 214, method 200 stops.

Turning now to FIG. 3, FIG. 3 is a flowchart illustrating an example method 300 for ranking search engines. For clarity of presentation, the description that follows generally describes method 300 in the context of FIG. 1. However, it will be understood that method 300 may be performed, for example, by any other suitable system, environment, software, and hardware, or a combination of systems, environments, software, and hardware as appropriate. For example, one or more of the enterprise portal server, the client, or other computing device (not illustrated) can be used to execute method 300 and obtain any data from the memory of the client, the enterprise portal server, or the other computing device (not illustrated).

At 302, context data is received. In some implementations, the retrieved context data is only applicable to a specific navigation node view. From 302, method 300 proceeds to 304.

At 304, metadata is received from the navigation node for the current view. From 304, method 300 proceeds to 306.

At 306, metadata for available search engines is received. In some implementations, the search engine metadata for available search engines can be stored within the context data. In other implementations, each search engine is queried for its metadata. From 306, method 300 proceeds to 308.

At 308, the context data is analyzed and the navigation node and search engine(s) metadata is compared consistent with the description above. From 308, method proceeds to 310.

At 310, a search engine ranking is determined consistent with the description above. After 310, method 300 stops.

Turning now to FIG. 4, FIG. 4 is a flowchart illustrating an example method 400 for determining the relevance of returned search results. For clarity of presentation, the description that follows generally describes method 400 in the context of FIG. 1. However, it will be understood that method 400 may be performed, for example, by any other suitable system, environment, software, and hardware, or a combination of systems, environments, software, and hardware as appropriate. For example, one or more of the enterprise portal server, the client, or other computing device (not illustrated) can be used to execute method 400 and obtain any data from the memory of the client, the enterprise portal server, or the other computing device (not illustrated).

At 402, a determination is made whether a received search result was selected by the enterprise portal user. In some implementations, an enterprise portal user can select a received search result using a GUI as described above or other suitable interface. If at 402, it is determined that the received search result was selected, method 400 proceeds to 404. If at 402, however, it is determined that the receive search result was not selected, method 400 proceeds as indicated to FIG. 2.

At 404, context data is recorded at least reflecting the selection of the search result. Other suitable data applicable to the selection of the search result may also be recorded to the context data, for example the enterprise portal user's navigation node view, the selected search engine, the entered search term(s), and/or the enterprise portal user's role. From 404, method 400 proceeds to 406.

At 406, a determination is made whether other enterprise portal users selected the same search result from the same search engine. If at 406, it is determined that other enterprise portal users selected the same search result from the same search engine, method 400 proceeds to 408 where context data is recorded to at least reflect an association between the other enterprise portal user's navigation node views and the selected search result and search engine. Other suitable data may also be recorded to the context data, for example, the other enterprise portal user's roles. From 406, method 400 proceeds to 410. If at 406, however, it is determined that other enterprise portal users did not select the same search result from the same search engine, method 400 proceeds to 410.

At 410, a determination is made whether an additional search was performed with the same search terms but a different search engine. If at 410, it is determined that an additional search was performed with the same search terms but with a different search engine, method 400 proceeds to 412 where context data is recorded to at least reflect the additional search, different search engine, and search terms. Other suitable data applicable to the additional search may also be recorded to the context data, for example the selected different search engine and/or the enterprise portal user's role. From 412, method 400 proceeds to 402. If at 410, however, it is determined that an additional search was not performed with the same search terms but with a different search engine, method 400 proceeds as indicated to FIG. 2.

In an alternate implementation, an enterprise portal user can make a search request of more than one search engine, for example an internal and an external search engine. In this implementation, the search service monitor 113 can connect to each search engine and make a search request, receive the separate search results, normalize the results according to commonly known or custom normalization methods, and return a ranking of the normalized search results based upon the normalized results.

The preceding figures and accompanying description illustrate example processes and computer implementable techniques. But example environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, in parallel, and/or in combination. In addition, many of the steps in these processes may take place simultaneously, concurrently, in parallel, and/or in different orders than as shown. Moreover, example environment 100 may use processes with additional steps, fewer steps, and/or different steps, so long as the methods remain appropriate.

In other words, although this disclosure has been described in terms of certain implementations and generally associated methods, alterations and permutations of these implementations and methods will be apparent to those skilled in the art. Accordingly, the above description of example implementations does not define or constrain this disclosure. Other changes, substitutions, and alterations are also possible without departing from the spirit and scope of this disclosure.

What is claimed is:

1. A method, comprising:
receiving, using at least one computer, a search request associated with a navigation node;
ranking available search engines;
receiving a selection of a search engine of the ranked available search engines and at least one search term;
recording context data associated with the received search engine selection and the at least one search term;
performing a search using the selected search engine and the at least one search term;
receiving search results; and
determining relevance of the returned search results.

2. The method of claim 1, wherein the ranking of the available search engines further comprises:
receiving context data associated with at least the navigation node;
receiving metadata from the navigation node;
receiving metadata from the available search engines;
analyzing the received context data;
comparing the metadata received from the navigation node and the available search engines; and
based upon the comparison, determining a ranking of the available search engines.

3. The method of claim 2, wherein the metadata comparison is at least one of a direct, statistical, Boolean, or logical.

4. The method of claim 1, wherein the recorded context data includes at least one of a navigation node view, the selected search engine of the ranked available search engines, the at least one search term, or a role.

5. The method of claim 1, further comprising determining whether a search result of the returned search results was selected.

6. The method of claim 5, further comprising determining whether at least one other enterprise portal user selected the same received search result from the same search engine.

7. The method of claim 6, further comprising determining whether an additional search was performed with the same search terms and a different search engine.

8. A computer-program product, the computer program product comprising computer-readable instructions embodied on tangible, non-transitory media, the instructions operable when executed to:
receive, using at least one computer, a search request associated with a navigation node;
rank available search engines;
receive a selection of a search engine of the ranked available search engines and at least one search term;
record context data associated with the received search engine selection and the at least one search term;
perform a search using the selected search engine and the at least one search term;
receive search results; and
determine relevance of the returned search results.

9. The computer-program product of claim 8, wherein the ranking of the available search engines further comprises instructions operable when executed to:
receive context data associated with at least the navigation node;
receive metadata from the navigation node;
receive metadata from the available search engines;
analyze the received context data;
compare the metadata received from the navigation node and the available search engines; and
based upon the comparison, determining a ranking of the available search engines.

10. The computer-program product of claim 9, wherein the metadata comparison is at least one of a direct, statistical, Boolean, or logical.

11. The computer-program product of claim 8, wherein the recorded context data includes at least one of a navigation node view, the selected search engine of the ranked available search engines, the at least one search term, or a role.

12. The computer-program product of claim 8, further comprising instructions operable when executed to determine whether a search result of the returned search results was selected.

13. The computer-program product of claim 12, further comprising instructions operable when executed to determine whether at least one other enterprise portal user selected the same received search result from the same search engine.

14. The computer-program product of claim 13, further comprising instructions operable when executed to determine whether an additional search was performed with the same search terms and a different search engine.

15. A system, comprising:
memory operable to store at least one navigation node; and
at least one hardware processor interoperably coupled to the memory and operable to:
receive, using at least one computer, a search request associated with a navigation node of the at least one navigation node;
rank available search engines;
receive a selection of a search engine of the ranked available search engines and at least one search term;
record context data associated with the received search engine selection and the at least one search term;
perform a search using the selected search engine and the at least one search term;
receive search results; and
determine relevance of the returned search results.

16. The system of claim 15, wherein the ranking of the available search engines further comprises:
receiving context data associated with at least the navigation node;
receiving metadata from the navigation node;
receiving metadata from the available search engines;
analyzing the received context data;
comparing the metadata received from the navigation node and the available search engines; and
based upon the comparison, determining a ranking of the available search engines.

17. The system of claim 16, wherein the metadata comparison is at least one of a direct, statistical, Boolean, or logical.

18. The system of claim 15, wherein the recorded context data includes at least one of a navigation node view, the selected search engine of the ranked available search engines, the at least one search term, or a role.

19. The system of claim 15, further comprising determining whether a search result of the returned search results was selected.

20. The system of claim 19, further comprising determining whether at least one other enterprise portal user selected the same received search result from the same search engine.

21. The system of claim 20, further comprising determining whether an additional search was performed with the same search terms and a different search engine.
